(19) United States
(12) Patent Application Publication
(10) Pub. No.: US 2004/0213077 A1
(43) Pub. Date: Oct. 28, 2004

(54) Plastic screw

(76) Inventor: Robert Dray, Dallas, TX (US)

Correspondence Address: Mark D. Perdue, Storm & Hemingway, L.L.P., Ste. 460, 8117 Preston Road, Dallas, TX, 75225, US

(21) Appl. No.: 10/421,223

(22) Filed: Apr. 23, 2003

(51) Int. Cl. A21C 1/06

(52) U.S. Cl. 366/88

(57) ABSTRACT

An apparatus for conveying and melting plastic materials has a containment barrel that supplies heat for melting the plastic. A shaft rotates within the barrel and has a diameter, a circumference, and a surface. At least one flight is secured to the shaft and extends helically around its circumference. The flight, shaft and barrel cooperate to define a channel between successive turns of the flight, the channel having a depth and a width that define a channel area. The flighted shaft has an entry section at an upstream end of the flighted shaft, a transition section, and a discharge section at a downstream end of the shaft, the channel area in the transition section is larger than in the entry section. The difference in area between the entry and transition sections provides the advantage that avoids surging conditions and improves mixing.

### BACKGROUND OF THE INVENTION

1. Field of the Invention

The present invention relates to improvements in the design of screws employed in the plastics processing industry to melt and convey plastic for extrusion and injection molding processes.

2. Summary of Prior Art

In the plastics industry, extruding and injecting plastic resins efficiently is critical to the product quality, productivity, and energy efficiency. Achieving efficiencies that are closer to enthalpy or greater pounds (of plastic) per hour per horsepower (of processing power input) improves all aspects of extruding and injecting resins.

In prior-art screw designs, the pressure required for compacting the solids bed is developed in the feed, entry, or inlet section (the upstream portion of the screw). The depth of the channel between successive turns of the flights typically reduces along the length of the screw and the lead stays constant. As the melting, mixing, or transition section transitions or tapers into the metering, discharge, or outlet section, where it is believed that shallowing the depth is necessary to compact the solids bed and thereby melt the resin so that it can be forced through the extrusion die or into the injection mold. This tapering reduces cross-sectional area and thus creates a “reverse” or “negative” mechanical advantage: increases in pressure downstream are actually attenuated upstream in the feed section.

In these prior-art screw designs, the inlet area (channel depth and/or width) is greater than the outlet area. This leads to many problems and complexity. For example, if the upstream viscosity is too high and the design does not have adequate pressure-building capability, downstream resin velocity is reduced and pressure increases until the viscosity is reduced to the necessary level for downstream velocity or flow to resume. This unstable process is referred to as surging.

In the event that the die pressure is too great for the pressure-building capability of the metering section, the pressure moves upstream. The transition and feed sections are then required to overcome not only this pressure, but also this pressure multiplied by the negative mechanical advantage. As the feed section attempts to supply this pressure, melting will occur too early in the feed section, creating melted resin on the forward side of the flights. When this happens, the solids in the feed section tends to adhere to the melted resin. This is undesirable because it reduces the pressure-building capability of the feed section by causing the solids to rotate with the screw to a greater degree, thereby effectively reducing the length of the feed section.

In the event that the pressure profile is correct in a prior-art design, the remaining solids bed near the end of the transition section is, essentially, “exploded” as the pressure becomes great enough to penetrate the remaining solids bed. This disperses the solids randomly in the metering section. These unmelted particles are unable to be completely melted as they proceed to the die or mold, therefore providing viscosity variations at best or “unmelts” in the finished part. Either defect normally results in an unacceptable finished product.

A need exists, therefore, for extrusion screw designs that avoid the negative mechanical advantage associated with the prior-art designs.

### SUMMARY OF THE INVENTION

It is a general object of the present invention to provide an apparatus for plastic extrusion that has improved characteristics due to the employment of a mechanical or hydraulic advantage within the screw design. There are two configurations, an injection version that has the availability of adjustable backpressure to provide the downstream resistance by means of a mixing device at the discharge end, and an extrusion version that does not normally have adjustable backpressure available.

This and other advantages are achieved by providing an apparatus for conveying and melting material that has a containment barrel, with heaters, that supplies heat to the resin by conductive heat transfer. A shaft rotates within the barrel and has a diameter, a circumference, and a surface. At least one flight is secured to the shaft and extends helically around its circumference. The flight, shaft and barrel cooperate to define a channel between successive turns of the flight, the channel having a depth and a width that define a channel area. The flighted shaft has an entry section at its upstream end, a discharge section at its downstream end, and a transition section between them. The channel area in the transition section is larger than in the entry section.

According to various embodiments of the invention, the channel area may be varied by changing the lead of the flight (which corresponds to the width of the channel) and/or the diameter of the shaft (which corresponds to the depth of the channel) so that the channel area in the transition or outlet section is larger than that in the inlet section.

### DESCRIPTION OF THE PREFERRED EMBODIMENT

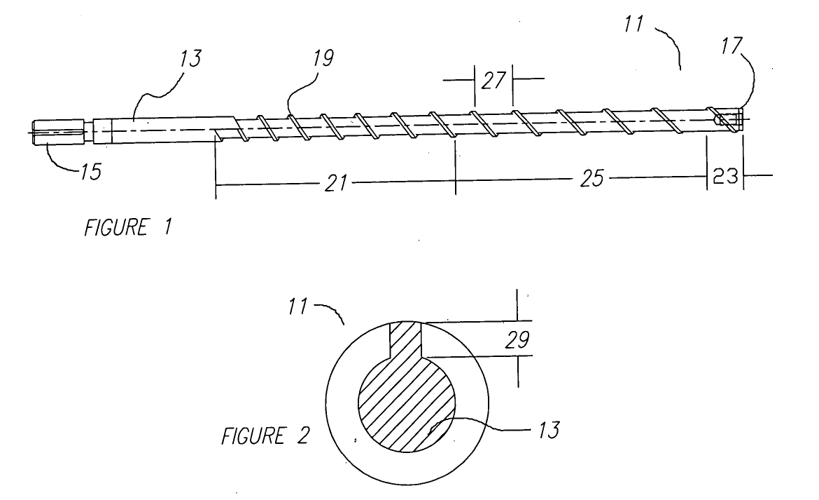

Referring now to the Figures, and particularly to FIG. 1, apparatus according to the present invention is illustrated. A screw 11 is adapted to rotate in a heated containment barrel to melt and mix solid plastic or polymer pellets or granules. Screw 11 comprises a shaft 13 having an upstream 15 and a downstream 17 end. At least one flight 19 (sometimes a second or auxiliary flight is provided as well), extends helically about the circumference of shaft 13 and defines an inlet, entry, or feed section 21 at the upstream end, where pellets are fed into the containment barrel and acted upon by screw 11. At the downstream end, a discharge, metering, or outlet section 23 is defined that is intended to deliver the molten and mixed plastic into the mold or die. A transition, mixing, or melting section 25 is provided between the feed and discharge sections 21, 23. A mixing device (not shown) having conventional characteristics may be added to the discharge end for an extrusion screw. A non-return valve (not shown) may be added to the discharge end for an injection screw.

FIG. 2 is a partial cross-section view of screw 11 of FIG. 1 in a containment barrel that illustrates the channel area. The distance 27 between successive adjacent turns of flight 19 is the channel width, while the distance 29 between the outer diameter surface of shaft 13 and containment barrel (shown in phantom) is the channel depth. The channel area is bounded by the turns of flight 19, shaft 13, and the barrel. According to the present invention, the channel width (flight lead) and depth (shaft diameter or flight depth) are selected so that the channel area is larger at all points through the transition section than at any point in the inlet section.

Various combinations of varying and constant shaft diameter and varying and constant lead can be employed so long as this basic principle is observed. Feed section 21 is designed to provide the necessary amount of resin at the required pressure to transition area 25. The transition 25 and metering sections 23 are designed not to develop pressure, but only to provide for the desired melting and flow rate. The pressure to compact solids in the feed section is created as the downstream pressure moves upstream and is met with a positive mechanical advantage created by the reduction in channel area in the feed section. As the solids bed is compacted upstream, the breaking up of the solids bed that disperses unmelted particles into the metering section in the prior art is eliminated. The melted resin is allowed to move through the reduced downstream pressure further increasing melting. This type of melting is optimized by the longer lead in the melting area providing greater melting area.

According to a preferred embodiment of the present invention, shaft 13 is 34.312 inches in overall length and 1.402 inches in diameter. At 11.75 inch along its length (measured from upstream end 15), a single flight 19 begins having a lead of 1.417 inch (spacing between adjacent successive turns) and a depth of 0.22 inch (shaft diameter reduced under the flight to 0.96 inch), which remains constant in this section, which corresponds to the inlet or feed section 21. After continuing along the length of the shaft for 14.5 inches (26.25 along the overall length measured from upstream end 15), the lead progressively expands from 1.417 to 3.239 inch in a linear fashion over a distance of 5.06 inch (measured from end of feed section 21). Simultaneously, the flight depth increases from 0.22 inch to 0.315 inch (shaft diameter constantly decreasing from 0.96 inch to 0.77 inch) for 5.06 inches along the length of shaft. This corresponds to the transition section 25. At 31.312 inch from the upstream end point the flight depth decreases to 0.065 inch (shaft diameter increases to 1.272 inch) in ¼ turn of the flight and then continues for 3 inches to the downstream end of the shaft. This section is the discharge section 23 of screw 11.

Thus, according to this embodiment of the present invention, both the width 27 and depth 29 of the channel are increased, in variable fashion through the transition section, so that the channel area is larger at all points in the transition section 25 than in the inlet section 21 . Due to the larger channel area in the transition section, pressure developed as the plastic is extruded or injected is exerted on the unmelted plastic in the inlet or feed section 21, thereby increasing the energy imparted to the melting and mixing plastic, improving the efficiency of those processes. According to the present invention, melting thus is controlled by downstream pressure. This allows the feed section to provide the required pressure on the melted resin to attain the desired flow rate and melt temperature. Minimum melt temperature is attained by the melted resin being forced downstream through the unmelted resin. Surging or unstable operation is essentially eliminated, and greater efficiencies are established due to the utilization of resistance as a positive factor rather than negative as in the prior art. As the resin is wedged or forced upstream by the downstream pressure, it is not allowed to destabilize the feed section by inadequate feed section pressure-building capabilities, as is seen in the prior art. As the compacting of the solids bed is controlled, optimum melting conditions are achieved. This present invention automatically develops the correct shear stress at the selected shear rate (rpm). This controlled melting allows for far wider ranges of resins and viscosities to be processed on the same screw design.

The invention has been described with reference to preferred embodiments thereof. It is thus not limited, but is susceptible to variations and modifications without departing from the scope and spirit of the invention, which is defined by the claims.

I claim:

1. Apparatus for conveying and melting material within a containment barrel that supplies heat for melting the plastic, the apparatus comprising:
a shaft rotatable within the barrel and having a diameter and a circumference, and a surface; at least one flight secured to the shaft and extending helically around the circumference of the shaft, the flight defining a channel between successive helical turns of the flight, the channel having a depth and a width that define a channel area;
the flighted shaft having an entry section at an upstream end of the flighted shaft, a discharge section at a downstream end of the shaft, and a transition section intermediate the entry and discharge sections, the channel area in the transition section being larger than in the entry section.

2. The apparatus according to claim 1, wherein the diameter of the shaft decreases from entry to discharge, thereby increasing the depth of the channel and the channel area.

3. The apparatus according to claim 1, wherein the lead of the flight increases in the transition section, thereby increasing the width of the channel.

4. The apparatus according to claim 1, wherein the width of the channel in the entry section is less than the width of the channel in the transition section.

5. The apparatus according to claim 1, wherein the depth of the channel in the entry section is less than the depth of the channel in the transition section.

6. The apparatus according to claim 1, wherein both the width and depth of the channel increase in the transition section.

7. Apparatus for conveying and melting material within a containment barrel that supplies heat for melting the plastic, the apparatus comprising:
a shaft rotatable within the barrel and having a diameter and a circumference, and a surface;
at least one flight secured to the shaft and extending in helical turns around the circumference of the shaft, the flight having a selected lead that defines a channel having a width and a depth between successive turns of the flight, the width and depth of the channel defining a channel area;
the flighted shaft having an entry section at an upstream end of the flighted shaft, a discharge section at a downstream end of the shaft, and a transition section intermediate the entry and discharge sections, the channel area in the transition section being larger than in the entry section.

8. The apparatus according to claim 7, wherein the diameter of the shaft decreases in the transition section, thereby increasing the depth of the channel and the channel area.

9. The apparatus according to claim 7, wherein the width of the channel increases in the transition section.

10. The apparatus according to claim 7, wherein the width of the channel in the entry section is less than the width of the channel in the transition section.

11. The apparatus according to claim 7, wherein the depth of the channel in the entry section is less than the depth of the channel in the transition section.

12. Apparatus for conveying and melting material within a containment barrel that supplies heat for melting the plastic, the apparatus comprising:
a shaft rotatable within the barrel and having a diameter and a circumference, and a surface; at least one flight secured to the shaft and extending helically around the circumference of the shaft, the flight defining a channel between successive helical turns of the flight, the channel having a depth and a width that define a channel area;
the flighted shaft having an entry section at an upstream end of the flighted shaft, a discharge section at a downstream end of the shaft, and a transition section intermediate the entry and discharge sections, the channel width and depth in the transition section being larger than in the entry section.

13. The apparatus according to claim 12, wherein the channel width and depth increase constantly along the lenght of the shaft in the transition section.
